(19) United States
(12) Patent Application Publication
(10) Pub. No.: US 2016/0341517 A1
(43) Pub. Date: Nov. 24, 2016

(54) SYSTEM AND METHOD FOR PRODUCING A CUSTOMIZED GRIP

(71) Applicant: Steven Hanby WILLIAMS, Mountain View, CA (US)

(72) Inventor: Steven Hanby WILLIAMS, Mountain View, CA (US)

(73) Assignee: Intelboss LLC, Mountain View, CA (US)

(21) Appl. No.: 14/718,680

(22) Filed: May 21, 2015

(51) Int. Cl. F41C 23/10; B29C 67/00

(52) U.S. Cl. CPC F41C 23/10; B29C 67/0055; B29C 67/0088; B33Y 10/00

(57) ABSTRACT

A system for producing a grip that is customized for a user includes a fabricator that fabricates the customized grip and a computer. The computer is configured to: obtain measurements of a hand of the user, generate a three-dimensional model of the hand based on the measurements, obtain a three-dimensional model of a grip, subtract the three-dimensional hand model from the three-dimensional grip model to obtain a three-dimensional model of the customized grip, and send fabrication instructions to the fabricator based on the three-dimensional model of the customized grip.

### BACKGROUND

Most tools and sporting equipment have handles that allow users to grip those devices. There have been recent improvements in grip ergonomics in many fields, including the field of firearms. For example, there has been a trend to include modular backstraps in handgun grips, so that the end user can change the grip circumference.

Some long guns, such as AR-15 pattern rifles and rifles that will accept an AR-15 style grip also have pistol grips. Pistol grips were originally added to rifles to mitigate recoil by directing all of the recoil energy in a straight line from the barrel to the shooter's shoulder. Another reason was to give the shooter greater control over the rifle during firing. These attributes are improved when a grip is properly matched to the shooter.

Custom pistol grips are currently available for rifles, including AR-15 pattern rifles. These grips allow for a user to select the front and/or back portion of the grip to change the grip size and include or remove generic finger grooves. The user can also select interchangeable portions that will allow the grip to more seamlessly attach to their individual rifle. Once the user has selected various options for the front and backstrap, the grip is installed on the rifle.

### SUMMARY

All of the aforementioned customizable grips have the disadvantage of not being ideally matched to the individual user (or individual shooter in those examples). They allow the shooter to obtain a better fit by giving the shooter several options, but they are not individually tailored. In recent years, AR-15 style rifles in larger calibers with heavier recoil have become increasingly common. Moreover, there are several other high-recoiling firearms such as shotguns and revolvers that come equipped with pistol grips. As a result, there is an even greater need for control and recoil mitigation on these types or firearms, and concurrently a greater need for more ergonomic grips. There remains a need in the art for grips that are tailored to each individual user in order to improve comfort and control, and mitigate forces transferred to the user's hand.

In view of the above, exemplary embodiments of the broad inventive concepts described herein provide a method of producing a grip that is customized for a user including executing the following steps on a computer: obtaining measurements of a hand of the user; generating a three-dimensional model of the hand based on the measurements; obtaining a three-dimensional model of a grip; and subtracting the three-dimensional hand model from the three-dimensional grip model to obtain a three-dimensional model of the customized grip. The method further includes fabricating the customized grip based on the three-dimensional model of the customized grip.

In some embodiments, the measurements are obtained from a photograph of the hand. In some embodiments, the photograph includes a scaling object that is used to obtain the measurements of the hand. In some embodiments, obtaining the photograph of the hand from the user through a web-based application is also executed on the computer. In some embodiments, the customized grip is fabricated by a three-dimensional printer. In some embodiments, the measurements include at least one of width of interphalangeal joints and distance between interphalangeal joints. In some embodiments, the measurements include at least one of thumb-V length and thumb-V height. In some embodiments, obtaining a three-dimensional model of a grip includes selecting a three-dimensional grip model from a plurality of different sized three-dimensional grip models based on the measurements. In some embodiments, determining a rotational orientation of the photograph, and adjusting the rotational orientation to a desired rotational orientation is also performed on the computer. In some embodiments, positioning the three-dimensional hand model relative to the three-dimensional grip model prior to subtracting the three-dimensional hand model from the three-dimensional grip model is also performed on the computer. In some embodiments, the customized grip is a pistol grip and includes a mount configured to mount to an AR-15 pattern rifle. In some embodiments, fabricating the customized grip based on the three-dimensional model of the customized grip includes fabricating a customized outer shell of the grip based on the three-dimensional model of the customized grip, and attaching the customized outer shell to a standard core.

Exemplary embodiments provide a system for producing a grip that is customized for a user including a fabricator that fabricates the customized grip and a computer. The computer is configured to: obtain measurements of a hand of the user, generate a three-dimensional model of the hand based on the measurements, obtain a three-dimensional model of a grip, subtract the three-dimensional hand model from the three-dimensional grip model to obtain a three-dimensional model of the customized grip, and send fabrication instructions to the fabricator based on the three-dimensional model of the customized grip.

In some embodiments, the fabricator is a three-dimensional printer. In some embodiments, the measurements include at least one of width of interphalangeal joints and distance between interphalangeal joints. In some embodiments, the measurements include at least one of thumb-V length and thumb-V height. In some embodiments, obtaining a three-dimensional model of a grip includes selecting a three-dimensional grip model from a plurality of different sized three-dimensional grip models based on the measurements. In some embodiments, the computer is further configured to position the three-dimensional hand model relative to the three-dimensional grip model prior to subtracting the three-dimensional hand model from the three-dimensional grip model. In some embodiments, the customized grip is a pistol grip that comprises a mount configured to mount to an AR-15 pattern rifle. In some embodiments, the fabricator fabricates a customized outer shell of the grip based on the three-dimensional model of the customized grip that is configured to be attached to a standard core.

### BRIEF DESCRIPTION OF THE DRAWINGS

FIG. 1 is a side view of a rifle equipped with a prior art pistol grip.

FIG. 2 is a side view of the rifle shown in FIG. 1 equipped with a customized pistol grip produced according to one embodiment.

FIG. 3 is a diagram of a user's hand showing measurements to be taken for producing a customized grip according to the embodiment shown in FIG. 2.

FIG. 4 is a diagram of photograph of a user's hand and a scaling object before alignment for use in the embodiment shown in FIG. 2.

FIG. 5a is a diagram of a user's finger showing measurements to be taken of the knuckles for producing a customized grip according to the embodiment shown in FIG. 2.

FIG. 5b is a diagram of a user's finger showing measurements to be taken of the finger tip for producing a customized grip according to the embodiment shown in FIG. 2.

FIG. 6 is a diagram of a user's hand showing measurements to be taken of the palm for producing a customized grip according to the embodiment shown in FIG. 2.

FIG. 7 is a view of a three-dimensional model of a user's hand for producing a customized grip according to the embodiment shown in FIG. 2.

FIG. 8 is a front quarter view of a three-dimensional model of the pistol grip according to the embodiment shown in FIG. 2, before subtracting the three-dimensional hand model.

FIG. 9 is a front quarter view of a three-dimensional model of the customized pistol grip according to the embodiment shown in FIG. 2.

FIG. 10 is an upper front quarter view of a three-dimensional model of the customized pistol grip according to the embodiment shown in FIG. 2.

FIG. 11 is an upper rear quarter view of a three-dimensional model of the customized pistol grip according to the embodiment shown in FIG. 2.

FIG. 12 is a flow chart of a method for producing a customized grip according to the embodiment of FIG. 2.

FIG. 13 is a block diagram of a system for producing a customized grip according to the embodiment of FIG. 2.

### DETAILED DESCRIPTION OF EXEMPLARY EMBODIMENTS

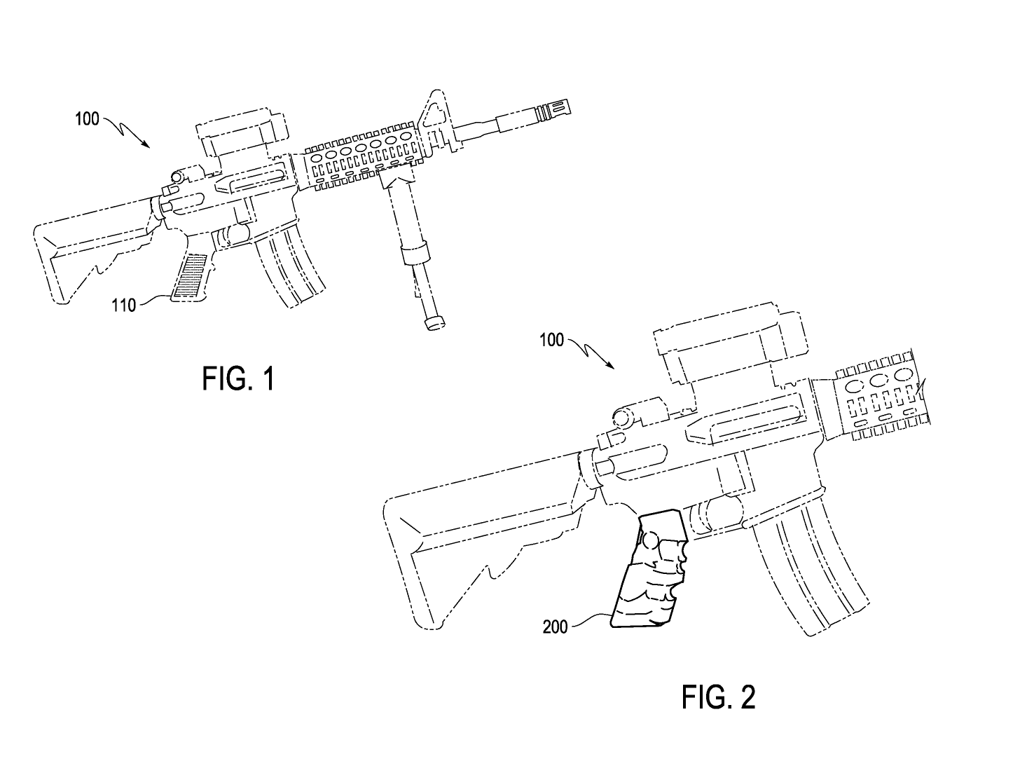

In several exemplary embodiments shown herein, a customized pistol grip for a firearm is produced. However, the systems and methods described herein may be used to produce customized grips for other tools, sporting goods, and devices, as described further below. FIG. 1 is a side view of a rifle 100 equipped with a prior art pistol grip 110, which is one exemplary firearm application of the systems and methods described herein. In some embodiments, rifle 100 is an AR-15 pattern rifle. The dimensions of prior art pistol grip 110 cannot be easily modified by the shooter. However, prior art pistol grip 110 is easily removable and can be replaced with a pistol grip that better fits the shooter's hand or has other desirable characteristics.

FIG. 2 is a side view of the rifle 100 shown in FIG. 1 equipped with a customized pistol grip 200 produced according to one embodiment. Customized pistol grip 200 can be easily installed after fabrication in this embodiment, because rifle 100 is equipped with a modular, removable pistol grip. However, it should be appreciated that the methods and systems described herein could be used for other firearms with or without easily removable grips, such as revolvers and shotguns. The methods and systems described herein could also be used to produce a customized foregrip for a firearm.

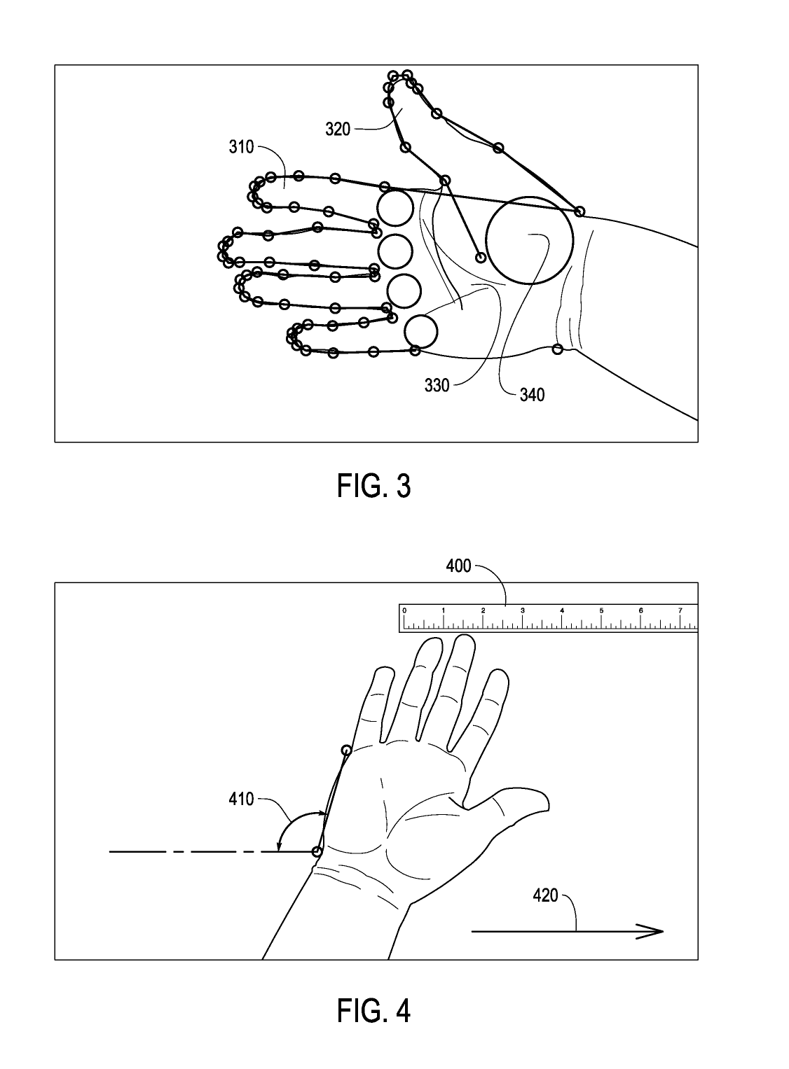

To produce customized pistol grip 200, measurements of a shooter's hand 300 are obtained. FIG. 3 is a diagram of a shooter's hand showing measurements to be taken to produce custom pistol grip 200. FIG. 4 is a diagram of photograph of a shooter's hand and a scaling object 400 before alignment for use in obtaining hand measurements. In this embodiment, scaling object 400 is a ruler. In this embodiment, the photograph shows hand 300 in an open position, clearly showing fingers 310, thumb 320, and palm 330.

The hand 300 is scaled by recording the size of the scaling object 400 in the photograph and inputting it into software in some embodiments. In some embodiments, the software user traces a line on scaling object 400 and enters the known length of the line into software. The software generates a scale for the photograph based on this information. Subsequently, when the software user traces dimensions on hand 300, the software calculates the dimensions based on the scale of the photograph.

In FIG. 3, hand 300 is oriented in a desired direction 420. In some embodiments, this orientation is generally parallel with the horizon of the photograph. As shown in FIG. 4, hand 300 may be orientated in a direction other than desired direction 420. In this case, in order to correct the orientation of hand 300, an angle 410 of hand 300 compared to desired direction 420. Angle 410 is either obtained based on a user input or determined by the software. Once angle 410 is obtained, hand 300 is rotated by the inverse of angle 410 orient hand 300 in a desired direction. In some embodiments, shooters submit photographs of their hands and scaling objects through a web-based application operated by a grip manufacturer. The grip manufacturer can then input necessary information into the computer to scale and properly orient the photographs, and subsequently take measurements of hands 300.

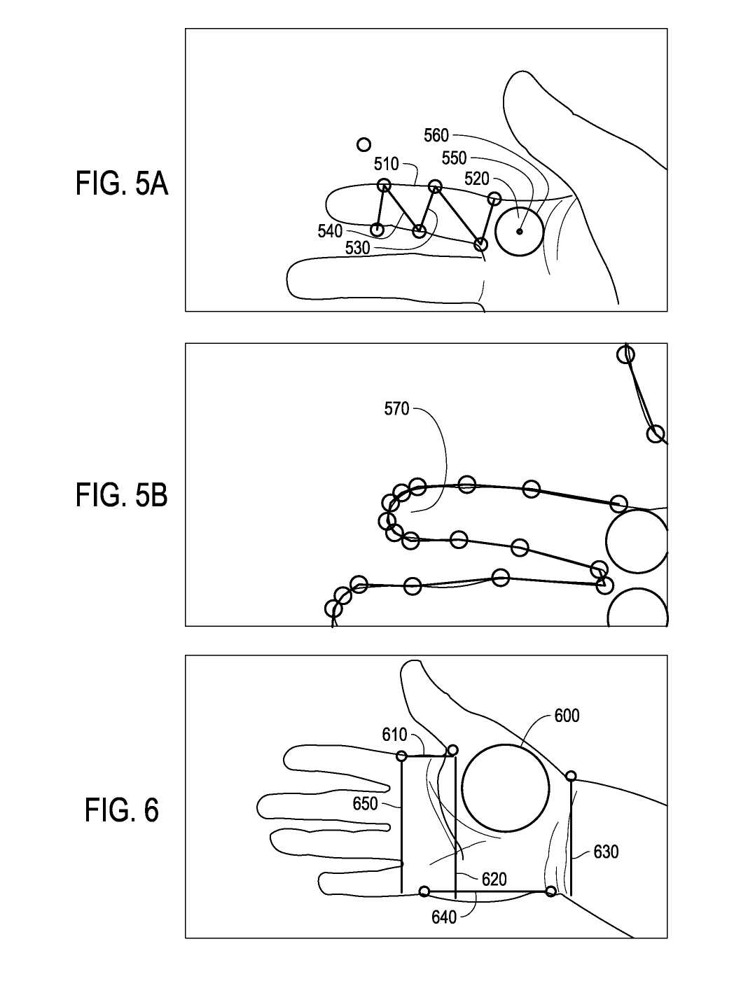

FIG. 5a is a diagram of a shooter's finger 310 showing measurements to be taken of the interphalangeal joints (IPs) 510 and metacarpophalangeal joints (MCP) 520. IP width measurements 530 are taken to measure the width of the IPs 510. IP distance measurements 540 are taken to measure the distance between IPs 510 and the proximal IP 510 to the MCP 520. MCP 520 is measured circumferentially by locating an approximate center point 550 and an approximate circumference 560.

FIG. 5b is a diagram of a shooter's finger showing measurements to be taken of the finger tip for producing a customized pistol grip for use in the embodiment shown in FIG. 2. The curvature is ascertained by analyzing a plurality of points along the end 570 of finger 310.

FIG. 6 is a diagram of a shooter's hand showing measurements to be taken of palm 330. These measurements include: the thumb-V length 610, thumb-V height 620, wrist height 630, palm length 640, and MCP height 650. In some embodiments, the heel of hand circumference 600 is also measured.

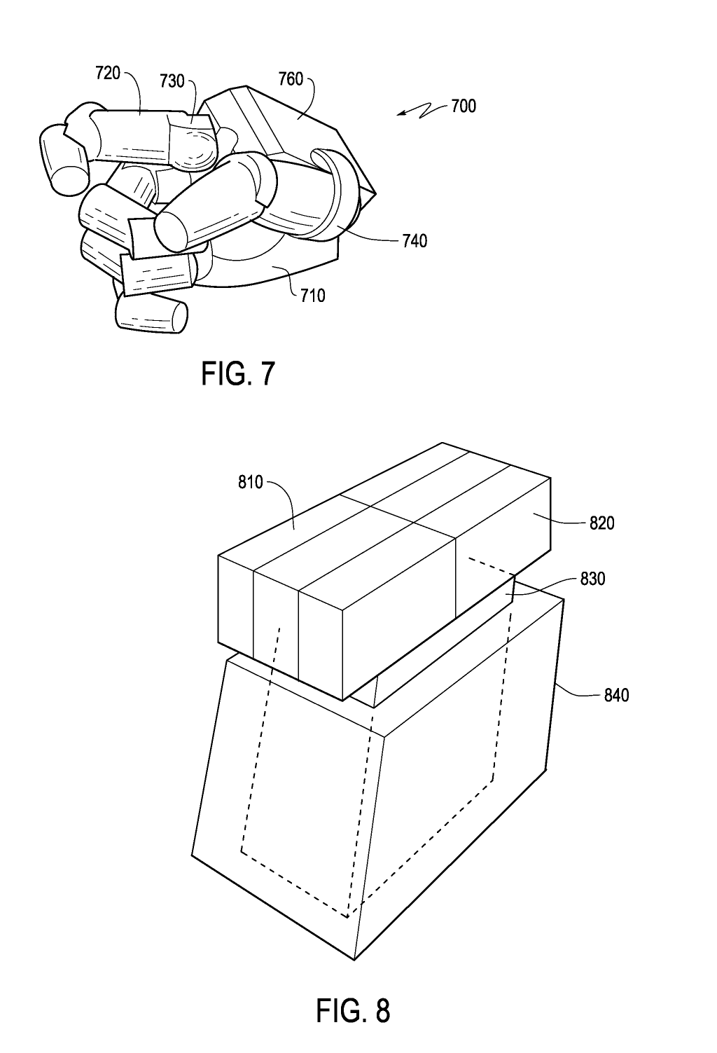

Once the measurements have been obtained, a three-dimensional model is created. FIG. 7 shows a view of an exemplary three-dimensional model 700 of a shooter's hand 300. The hand model 700 is created in several parts in this embodiment. First, the palm model 710 is created, then each of the finger models 720 and MCP models 730 are modeled and moved into place. The thumb model 740 and hand web model 760 are then created and moved into place.

To create the palm outline, a planar outline is created using the thumb-V length 610, thumb-V height 620, wrist height 630, palm length 640, and MCP height 650 and then extruded upwards. A circular cutout 770 is made in the center of palm model 710 for extra traction on the grip.

In some embodiments, each finger model 720 is created by extruding a number of cylindrical frusta to the length of each finger 310 using IP distance measurements 540 and finger end measurements 570. Segments of finger models 720 are then moved into position, starting at the tip and working toward the MCP model 730. In some embodiments, each finger model 720 is extended slightly outward to ensure that the finger grooves in the customized grip 200 will not have extra material. The tip of the finger model 720 is modeled as several aligned segments. In some embodiments, moving a finger into place is accomplished by using the position of the corresponding MCP and adding a slight offset.

MCP models 730 are then added to hand model 700. MCP radii are determined using MCP center points 550 and MCP circumferences 560. Spheres of the same size as MCPs 520 are intersected with a cylinder orthogonal to a normal axis of each MCP 520, then scaled slightly along the MCP normal axis. The resulting shape is then moved into place.

The thumb 320 is modeled using a different technique than fingers 310, because of its opposable properties and different musculature. In this embodiment, each finger 310 is modeled the same way. However, when modeling thumb 320, an outline of the thumb musculature is individually modeled and moved into place. The webbing model 760 is created by modifying the outline used by the thumb muscle and subtracting a vertical cylinder to simulate the compression of the thumb webbing.

The hand model 700 is capable of being articulated into a wide variety of configurations based on the positioning data used. In some embodiments, position data is obtained by creating a foam test object of the grip in question, then measuring the joint angles while a person is holding it. Some offsets can be used to compensate for differently sized hands, but given that the size of the grip is scaled based on hand size, these may not be needed for most hand sizes.

In some embodiments, each finger 310 has at least 4 angles recorded—the rotation of the finger in general, as well as the angle of each IP joint 510. In addition, the thumb 320 has a value for its rotation based on the angle at the thumb webbing. The rotation of the palm 330 is also measured and applied, but it is fairly negligible in most embodiments. The positions of finger 310, thumb 320, and palm 330 portions of the hand model 700 can also be adjusted based on shooter preference. This will result in a customized grip position in addition to a customized grip shape for customized grip 200.

After a three-dimensional model of the hand is created, it is subtracted from the blank grip model. FIG. 8 is a front quarter view of a three-dimensional model of a blank pistol grip model 800, before subtracting the three-dimensional hand model. Blank pistol grip model 800 includes a mounting portion 810. In some embodiments, mounting portion 810 is configured to mount customized pistol grip 200 to a firearm having an AR-15 style pistol grip mount. In some embodiments, the dimensions of blank pistol grip model 800 are set based on measurements of the hand, or one of a variety of different sized blank pistol grip models 800 are selected from based on the hand measurements. Blank pistol grip model 800 also includes a cutout 820 for the firearm safety in this embodiment.

The grip model 800 is created by first defining a set of points that will form the base, including the mounting portion 810 (including attachment points for a mil-spec AR-15/M16 grip), the grip base points, and the back points. The back of grip model 800 is sized based on the length of the fingers 310 and size of the palm 330 using one or more of the palm measurements 600-650, and finger measurements 540-570. This set of points is then extruded by a given distance based on the length of the user's fingers and the size of the palm.

In the embodiment of FIG. 8, grip model 800 includes core 830 and shell 840, which will be fabricated separately. Core 830 can be a standard size and may be fabricated by injection molding. Core 830 includes mounting portion 810. Shell 840 is used to fit custom grip 200 to each individual user, and is the portion from which hand model 700 is subtracted. Shell 840 is fabricated using a three-dimensional (3D) printer in some embodiments. After fabrication of core 830 and shell 840, the two components are coupled to each other using, for example, welding or gluing. Using this configuration of separate core 830 and shell 840, the customized grip can be produced more quickly and inexpensively. Moreover, core 830 can be made sturdier, and because it will bear the majority of the stresses and loads of customized grip 200 this improves the overall strength of customized grip 200. This also reduces the weight of customized grip 200.

To make customized grip model 900, the hand model 700 is rotated to be in the same orientation as the blank grip model 800, and positioned relative to the grip. In some embodiments, the relative positioning of blank grip model 800 and hand model 700 is based on the firearm that the customized pistol grip 200 will be used on. For rifles, the greatest comfort is usually achieved by keeping the axis of the palm, the axis of the rifle, and the integral of direction of trigger pull as parallel as possible.

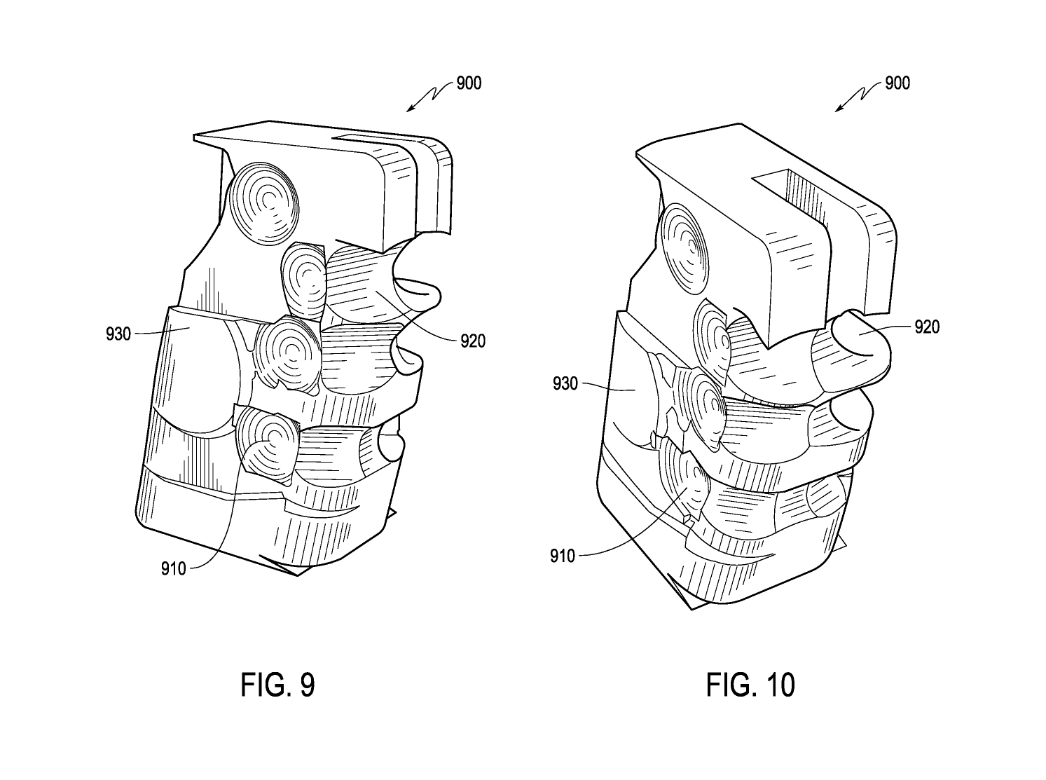

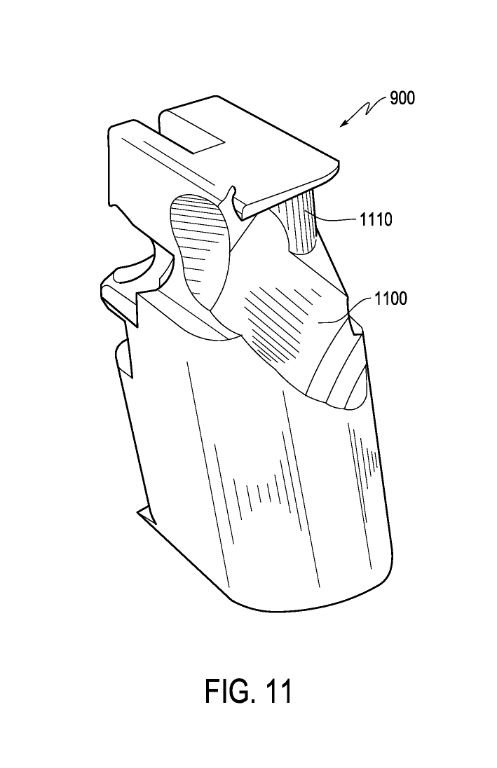

FIGS. 9-11 are views of customized pistol grip model 900. Customized pistol grip model 900 is the result of subtracting a three-dimensional hand model 700 from the blank grip model 800. Customized pistol grip model 900 includes MCP grooves 910, finger grooves 920, and palm extension 930 in this embodiment. MCP grooves 910, finger grooves 920, and palm extension 930 are dimensioned based on the three dimensional hand model 700. The MCP grooves 910 are added in to make it easier for a customer to position their hand, and palm extension 930 gives the shooter a more secure grip. Customized grip model 900 also includes thumb groove 1100 and web groove 1110 to accommodate the shooter's thumb and web of the hand, respectively. Features 910-930 on customized pistol grip model 900 are custom tailored to each shooter and allow the shooter have an ideal grip on rifle 100. This mitigates recoil and allows greater control during firing in part by preventing unusual torques or other forces from acting on the shooter's hand 300 during firing that would be generated by an imperfect interface between the hand 300 and a conventional pistol grip 110.

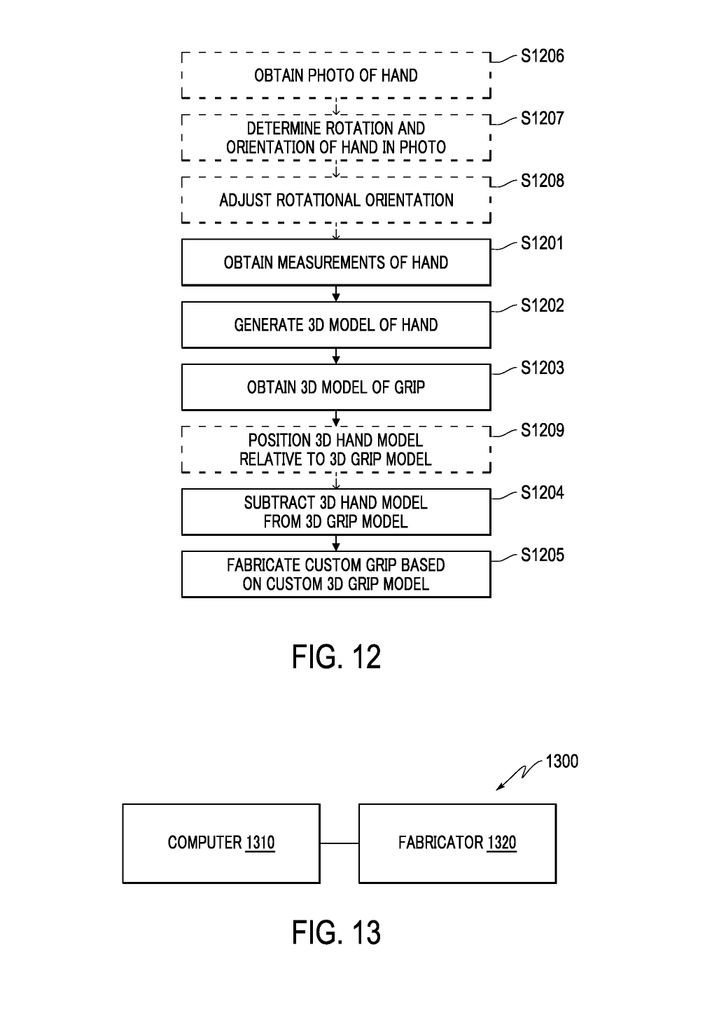

FIG. 12 is a flow chart of a method according to several embodiments. The method includes obtaining measurements of a hand of the user (S1201). The method further includes generating a three-dimensional model of the hand based on the measurements (S1202). The method further includes obtaining a three-dimensional model of a grip (S1203). The method further includes subtracting the three-dimensional hand model from the three-dimensional grip model to obtain a three-dimensional model of the customized grip (S1204). The method further includes fabricating the customized grip based on the three-dimensional model of the customized grip (S1205). In some embodiments, the method further includes obtaining the photograph of the hand from the user through a web-based application (S1206). In some embodiments, the method further includes determining a rotational orientation of the hand in the photograph (S1207). In some embodiments, the method further includes adjusting the rotational orientation to a desired rotational orientation (S1208). In some embodiments, the method further includes positioning the three-dimensional hand model relative to the three-dimensional grip model prior to subtracting the three-dimensional hand model from the three-dimensional grip model (S1209). In several embodiments steps S1201-S1204 and S1206-S1209 are performed on one or more computers, using software executing on the computer(s).

FIG. 13 is a block diagram of a system 1300 according to one embodiment. System 1300 includes computer 1310 and fabricator 1320. Computer 1310 may include a processor, CPU, microcontroller, or fully programmable gate array. Computer 1310 may be a server (alone or in concert with a computer operating a web browser) operating a web-based application. Computer 1310 may further include memory such as RAM, ROM, or flash memory, and storage such as a hard disk drive or flash storage. Fabricator 1320 is a 3D printer in some embodiments. In some embodiments, fabricator 1320 is an injection or blow molder. In some embodiments fabricator 1320 is a CNC machine tool. In some embodiments, fabricator 1320 is a combination of fabrication devices such as a 3D printer, an injection mold, and a chemical welder.

The systems and methods described herein may be used to produce customized grips for sporting equipment such as: ski poles, motorcycles, bicycles, climbing equipment, crew oars, swords, free weights, golf clubs (such as drivers, putters, and fairway woods/irons), archery bows, and paintball markers. In the golf club application, multiple hand positions may be desired by the user. A customized grip can be produced allowing multiple hand positions by generating three hand models in different configurations and subtracting each of them from the grip model.

The systems and methods described herein may be used to produce customized grips for medical equipment such as: crutches, canes, shower grips, walkers, surgical instruments, robotic surgery tools, and plasma scalpels. Many of these devices are load bearing, slippery, and/or require precise control. A customized grip allows for greater comfort, control, and grip of these devices.

The systems and methods described herein may be used to produce customized grips for hand tools such as: hammers, power tools, screwdrivers, and hand saws. Hand tools with customized grips may improve comfort, particularly for users suffering from arthritis. The systems and methods described herein may also be used to produce customized grips for devices such as: computer mice, riot batons, riot shields, and joysticks. To produce customized grips for each of the above-listed devices, grip models for the devices are obtained for the specific device, and a hand model is subtracted from that grip model.

Although the invention has been described with reference to embodiments herein, those embodiments do not limit the scope of the invention. Modifications to those embodiments or different embodiments may fall within the scope of the invention.

What is claimed is:

1. A method of producing a grip that is customized for a user, comprising:
executing the following steps on a computer:
obtaining measurements of a hand of the user;
generating a three-dimensional model of the hand based on the measurements;
obtaining a three-dimensional model of a grip; and
subtracting the three-dimensional hand model from the three-dimensional grip model to obtain a three-dimensional model of the customized grip; and
fabricating the customized grip based on the three-dimensional model of the customized grip.

2. The method of claim 1, wherein the measurements are obtained from a photograph of the hand.

3. The method of claim 2, wherein the photograph includes a scaling object that is used to obtain the measurements of the hand.

4. The method of claim 2, wherein the following step is further executed by the computer:
obtaining the photograph of the hand from the user through a web-based application.

5. The method of claim 1, wherein the customized grip is fabricated by a three-dimensional printer.

6. The method of claim 1, wherein the measurements include at least one of: width of interphalangeal joints and distance between interphalangeal joints.

7. The method of claim 1, wherein the measurements include at least one of: thumb-V length and thumb-V height.

8. The method of claim 1, wherein obtaining a three-dimensional model of a grip includes selecting a three-dimensional grip model from a plurality of different sized three-dimensional grip models based on the measurements.

9. The method of claim 2, wherein the following steps are further executed by the computer:
determining a rotational orientation of the hand in the photograph; and
adjusting the rotational orientation to a desired rotational orientation.

10. The method of claim 1, wherein the following step is further executed by the computer:
positioning the three-dimensional hand model relative to the three-dimensional grip model prior to subtracting the three-dimensional hand model from the three-dimensional grip model.

11. The method of claim 1, wherein the customized grip is a pistol grip that comprises a mount configured to mount to an AR-15 pattern rifle.

12. The method of claim 1, wherein fabricating the customized grip based on the three-dimensional model of the customized grip includes:
fabricating a customized outer shell of the grip based on the three-dimensional model of the customized grip; and
attaching the customized outer shell to a standard core.

13. A system for producing a grip that is customized for a user, comprising:
a fabricator that fabricates the customized grip; and
a computer configured to:
obtain measurements of a hand of the user;
generate a three-dimensional model of the hand based on the measurements;
obtain a three-dimensional model of a grip;
subtract the three-dimensional hand model from the three-dimensional grip model to obtain a three-dimensional model of the customized grip; and
send fabrication instructions to the fabricator based on the three-dimensional model of the customized grip.

14. The system of claim 13, wherein the fabricator is a three-dimensional printer.

15. The system of claim 13, wherein the measurements include at least one of: width of interphalangeal joints and distance between interphalangeal joints.

16. The system of claim 13, wherein the measurements include at least one of: thumb-V length and thumb-V height.

17. The system of claim 13, wherein obtaining a three-dimensional model of a grip includes selecting a three-dimensional grip model from a plurality of different sized three-dimensional grip models based on the measurements.

18. The system of claim 13, wherein the computer is further configured to:
position the three-dimensional hand model relative to the three-dimensional grip model prior to subtracting the three-dimensional hand model from the three-dimensional grip model.

19. The system of claim 13, wherein the customized grip is a pistol grip that comprises a mount configured to mount to an AR-15 pattern rifle.

20. The system of claim 13, wherein the fabricator:
fabricates a customized outer shell of the grip based on the three-dimensional model of the customized grip that is configured to be attached to a standard core.
